(19) United States
(12) Patent Application Publication
(10) Pub. No.: US 2015/0336233 A1
(43) Pub. Date: Nov. 26, 2015

(54) CONDITIONING ONE OR MORE INTERNAL SURFACES OF AN OBJECT

(71) Applicant: United Technologies Corporation, Hartford, CT (US)

(72) Inventors: Wendell V. Twelves, Glastonbury, CT (US); Lyutsia Dautova, Rocky Hill, CT (US); Evan Butcher, Manchester, CT (US); Joe Ott, Enfield, CT (US); Matthew E. Lynch, Canton, CT (US)

(21) Appl. No.: 14/720,300

(22) Filed: May 22, 2015

Related U.S. Application Data
(60) Provisional application No. 62/002,464, filed on May 23, 2014.

(51) Int. Cl. B24B 31/00; B24B 31/06

(52) U.S. Cl. CPC B24B 31/006; B24B 31/064; B33Y 10/00

(57) ABSTRACT

A process is provided involving an agitator. This process includes steps of: (a) disposing an object with the agitator, which object includes an aperture therein; (b) disposing abrasive material within the aperture; and (c) agitating the abrasive material by moving the object using the agitator.

### CROSS-REFERENCE TO RELATED APPLICATION

This application claims priority to U.S. Provisional Patent Application No. 62/002,464 filed May 23, 2014, which is hereby incorporated herein by reference in its entirety.

### BACKGROUND OF THE INVENTION

1. Technical Field

This disclosure relates generally to surface conditioning and, more particularly, to conditioning an internal surface of an object, for example, to reduce surface roughness of and/or polish the surface.

2. Background Information

Various components of a turbine engine may include one or more internal passages; e.g., gas or lubricant passages. A rotor blade airfoil, for example, may include a circuit of internal passages for directing cooling air therewithin to cool the airfoil. Such components are typically formed by casting. Surfaces of a cast component, however, may have a relatively high surface roughness. These rough surfaces may reduce structural integrity of the component and/or turbulate gas flowing through the passages.

Various surface finishing processes such as machining and media blasting may be performed for reducing surface roughness of exterior surfaces of a component. However, such surface finishing processes cannot be used on interior surfaces of the component where there is no direct line of sight; e.g., surfaces defining internal passages.

Some specialized processes have been developed for finishing internal surfaces of a component. These processes involve flowing abrasive media through passages of the component. The media may rub against the internal surfaces, thereby grinding away material of the component and partially reducing the surface roughness of the internal surfaces. Such processes, however, may be ineffective for conditioning an internal passage with twists and bends. For example, referring to FIG. 13, abrasive media flowing through the passage 1300 of the component 1302 will tend to move towards a radial outer periphery of the passage bend. Therefore, a radial outer portion 1304 of the internal surface defining the passage 100 will receive significantly more surface finishing than the opposing radial inner portion 1306 of the surface.

There is a need in the art for improved systems and processes for conditioning internal surface(s) of an object such as, for example, a turbine engine component.

### SUMMARY OF THE DISCLOSURE

According to an aspect of the invention, a process is provided involving an agitator. This process includes steps of: (a) disposing an object with the agitator, which object includes an aperture therein; (b) disposing abrasive material within the aperture; and (c) agitating the abrasive material by moving the object using the agitator.

According to another aspect of the invention, a system is provided for conditioning an internal surface of an object, where the internal surface defines at least a portion of an aperture in the object. The system includes a material displacement device adapted to dispose abrasive material into the aperture. The system also includes an agitator adapted to agitate the abrasive material by moving the object. Agitation of the abrasive material may reduce surface roughness of the internal surface.

The agitator may be adapted to move the object along at least one axis. The agitator may also or alternatively be adapted to move the object about at least one axis.

The moving may include shaking the object using the agitator.

The moving may include moving the object relative to a first axis using the agitator. The moving may also include moving the object relative to a second axis using the agitator. The moving may still also include moving the object relative to a third axis using the agitator.

The object may move back and forth along the first axis. The object may also or alternatively move back and forth about the first axis.

The abrasive material may be displaced using a material displacement device. The abrasive material may be displaced by a pulse of fluid directed from the material displacement device. The material may be displaced before, after and/or during the moving of the object.

At least some of the abrasive material may be removed (e.g., purged) from the aperture. Second abrasive material may be disposed into the aperture. The second abrasive material may be agitated by moving the object using the agitator.

At least a portion of the object, which includes the aperture, may be additive manufactured.

At least a portion of the object, which includes the aperture, may be cast.

The aperture may be one of a plurality of apertures in the object. The abrasive material may be disposed in at least one or some or each of the apertures.

The abrasive material may be or include dry powder media. Alternatively, the abrasive material may be or include a slurry of powder media in a liquid.

The agitating of the abrasive material may reduce surface roughness of an internal surface of the object, which internal surface defines at least a portion of the aperture. The abrasive material, for example, may polish at least a portion of the internal surface.

The foregoing features and the operation of the invention will become more apparent in light of the following description and the accompanying drawings.

### BRIEF DESCRIPTION OF THE DRAWINGS

FIG. 1 is a side sectional illustration of an object with an internal aperture.

FIG. 2 is a cross-sectional illustration of the object of FIG. 1.

FIG. 3 is a block diagram of a system for conditioning at least one internal surface of an object.

FIG. 4 is another side sectional illustration of the object of FIG. 1 with abrasive material within its internal aperture.

FIG. 5 is another side sectional illustration of the object of FIG. 2 with abrasive material within its internal aperture.

FIG. 6 is a perspective illustration of an agitator.

FIG. 7 is a perspective cutaway illustration of a fixture for housing an object.

FIG. 8 is a side sectional illustration of the fixture of FIG. 7.

FIG. 9 is a perspective illustration of another agitator.

FIG. 10 is a flow diagram of a process involving a conditioning system.

FIG. 11 is an enlarged view of a portion of the object of FIG. 5 at point A.

FIG. 12 is a side cutaway illustration of a geared turbine engine.

FIG. 13 is cross-sectional illustration of an object with abrasive media flow through an internal passage.

### DETAILED DESCRIPTION OF THE INVENTION

Various types of objects may be formed with one or more internal apertures; e.g., passages, channels, bores, voids, chambers, etc. One or more of these apertures may be configured to provide fluid flowpath(s) into, out of, within and/or through the object. A ring of a bearing, for example, may include one or more passages for distributing lubricant to roller elements of the bearing. In another example, a rotor blade for a turbine engine may include one or more passages and/or chambers for directing coolant (e.g., air) therewithin to cool an airfoil of the rotor blade. One or more of the apertures (e.g., the passages and/or chambers) may also or alternatively be included to reduce mass and weight of the object (e.g., rotor blade).

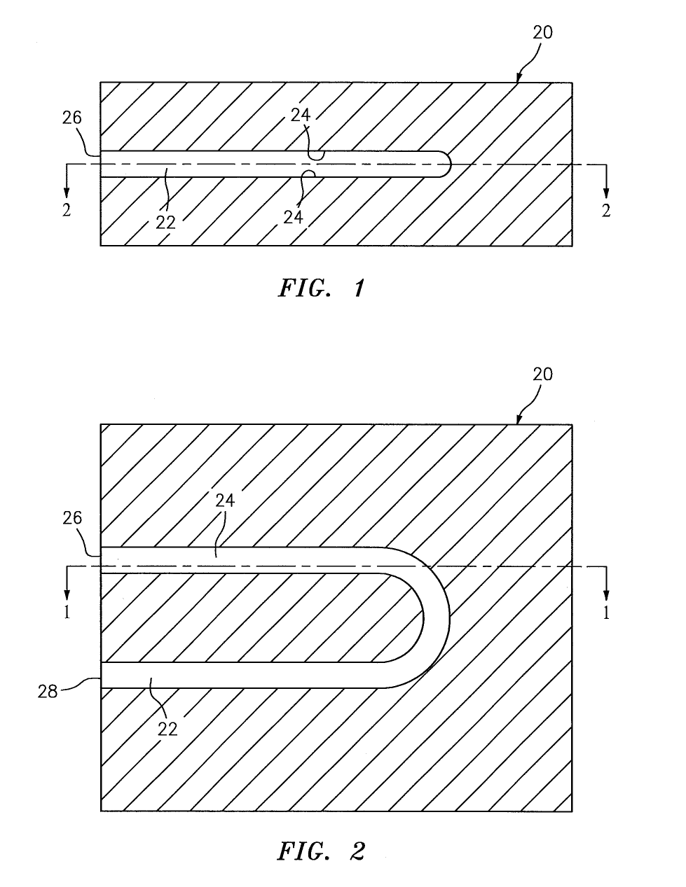

An exemplary object 20 with an internal aperture 22 (e.g., a tortuous and/or serpentine passage) is illustrated in FIGS. 1 and 2. This aperture 22 is defined by at least one internal surface 24 of the object 20. The aperture 22 extends through the object 20 between a first orifice 26 and a second orifice 28, which orifices 26 and 28 may be disposed on a common side of the object 20. Of course, in other embodiments, the orifices 26 and 28 may be disposed on different or even opposing sides of the object 20.

The object 20 may be formed using one or more manufacturing processes as discussed below in further detail. Subsequent to object 20 formation, at least a portion of the surface 24 may have a relatively large surface roughness. This may be particularly true where the object 20 is formed using additive manufacturing and/or casting. If left unconditioned, such a rough surface may reduce structural integrity of the object 20 and/or turbulate fluid flowing through the aperture 22.

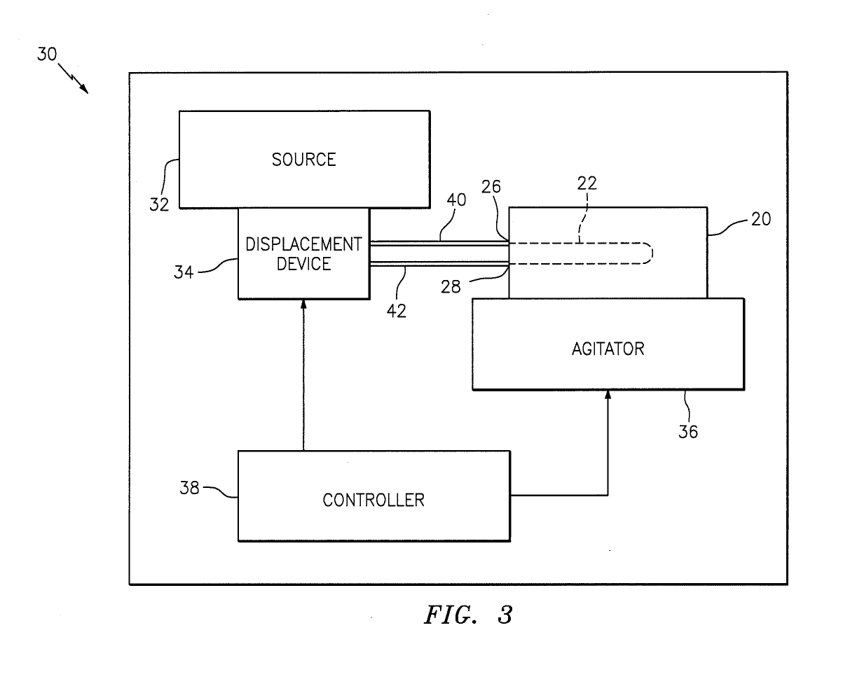

FIG. 3 is a block diagram of a system 30 for conditioning at least one internal surface of an object such as the internal surface 24 of FIGS. 1 and 2. This conditioning system 30, for example, may be adapted to reduce the surface roughness of and/or polish the surface 24 using abrasive material. The condition system 30 may also or alternatively prepare (e.g., score) the surface 24 to receive a coating using abrasive material.

The conditioning system 30 includes a material source 32 (e.g., a hopper or tank), an abrasive material displacement device 34 and an agitator 36. The conditioning system 30 also includes a controller 38, which is in signal communication (e.g., hardwired and/or wirelessly connected) with the system components 34 and 36.

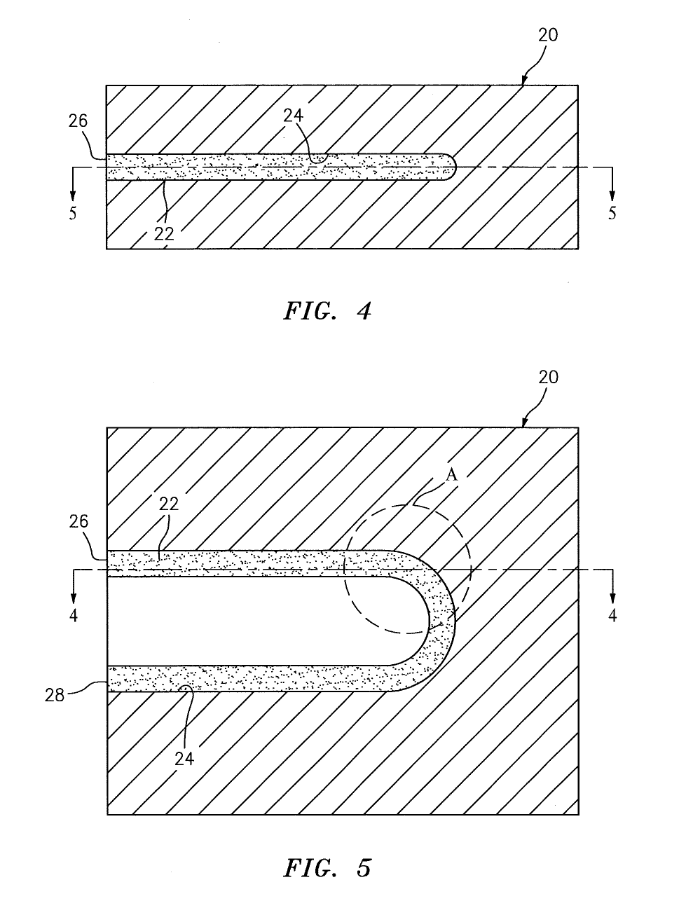

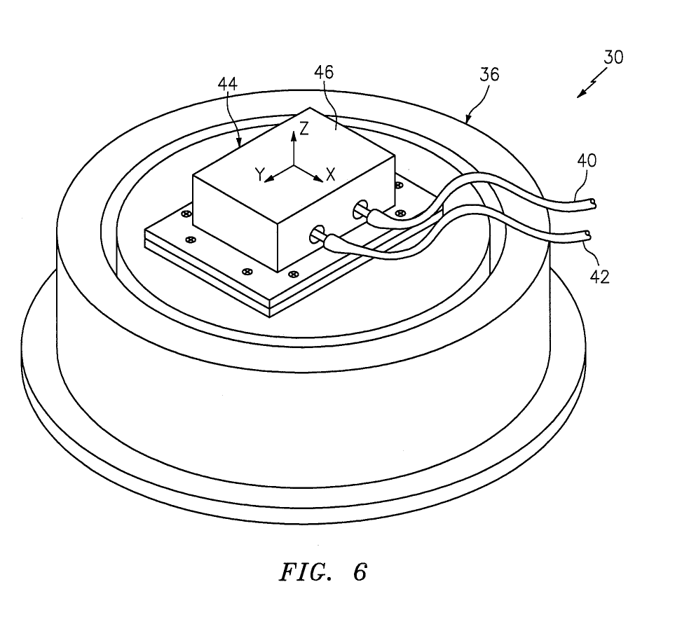

The material displacement device 34 is fluidly coupled with one or more of the orifices 26 and 28 through one or more fluid conduits 40 and 42; e.g., pipes, hoses, channels, troughs, etc. The material displacement device 34 is adapted to direct a quantity of the abrasive material from the material source 32 into the aperture 22 (see FIGS. 4 and 5). The material displacement device 34 may also be adapted to partially displace (e.g., shift, push or siphon) the abrasive material within the aperture 22. The material displacement device 34 may also or alternatively be adapted to remove (e.g., flush or purge) the abrasive material from the aperture 22. The removed abrasive material may subsequently be discarded, or returned to the material source 32 for later use.

The material displacement device 34 may be configured as or include a pump, a hopper screw and/or a conveyor. The material displacement device 34 may also or alternatively be configured as or include a fluid pressure source; e.g., a compressed gas (e.g., air or inert gas) source. In such an embodiment, fluid (e.g., compressed air) may be used to siphon the abrasive material from the material source 32 and direct (e.g., push) the siphon abrasive material into the aperture 22. The conditioning system 30 of FIG. 3, however, is not limited to the exemplary material displacement device configurations described above.

The agitator 36 is adapted to move (e.g., shake and/or vibrate) the object 20 in order to agitate the abrasive material disposed within the aperture 22 (see FIGS. 4 and 5). The agitator 36, for example, may be adapted to move (e.g., oscillate) the object 20 back and forth along one or more axes. The agitator 36 may also or alternatively be adapted to move the object 20 back and forth about one or more axes. In addition, the agitator 36 may include a base for supporting the object 20. The agitator 36, for example, may be configured as a single axis or multi-axis shaker and/or vibrator.

FIG. 6 illustrates an exemplary embodiment of the agitator 36. In this embodiment, the agitator 36 is configured as a multi-axis (e.g., 3-axis) voice coil shaker. FIG. 6 also illustrates a fixture 44 for securing the object 20 to the agitator 36.

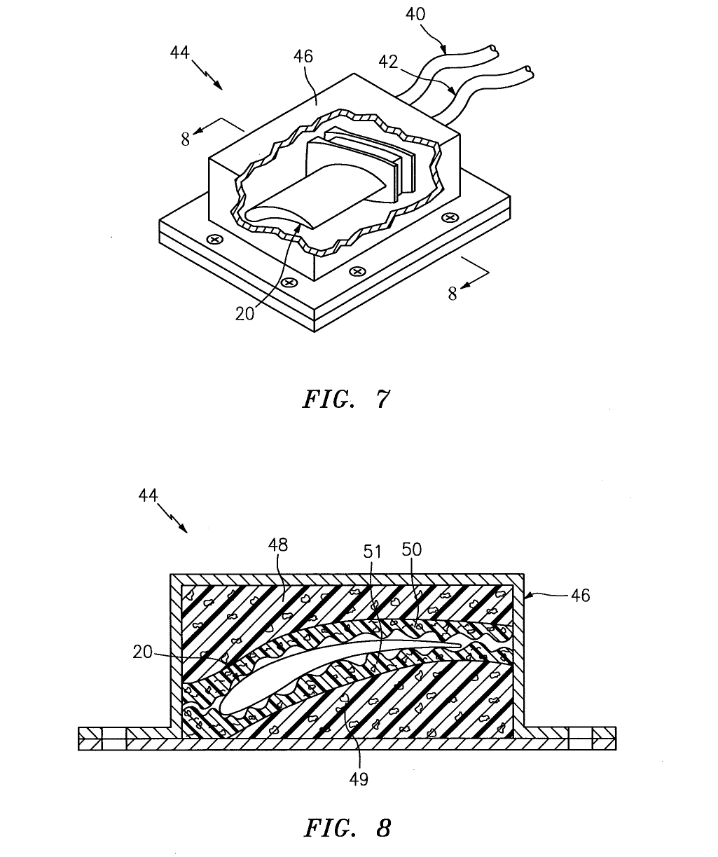

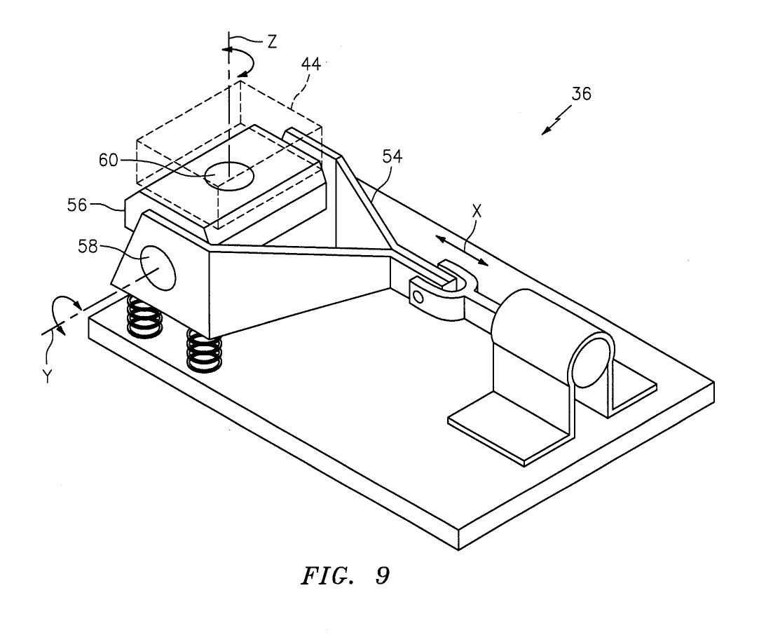

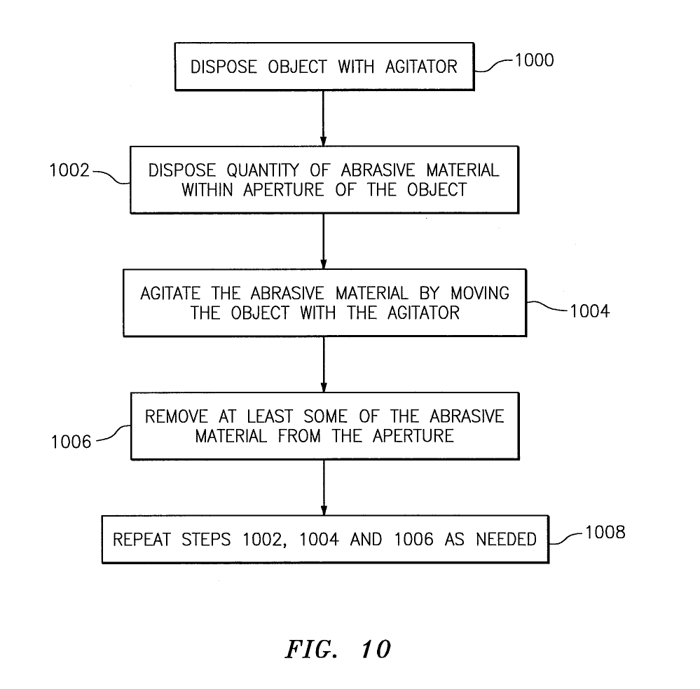

Referring to FIGS. 7 and 8, the fixture 44 includes a casing 46 (e.g., a sealed or vacuum enclosure) configured to house the object 20 as well as mount to the agitator 36 via, for example, one or more fasteners (see FIG. 6) and/or latches. The fixture 44 may also include one or more inserts 48-51 to support the object 20 within the casing 46; e.g., cushion and/or firmly hold the object 20 during movement. The inserts may include one or more rigid outer fillers 48 and 49; e.g., styrofoam fillers. The inserts may also or alternatively include one or more flexible inner fillers 50 and 51; e.g., cushions and/or elastomeric fillers. One or more of the inserts 48-51 may be removable such that these insert(s) may be swapped out or removed depending upon the specific object being housed within the casing 46. Alternatively, one or more of the inserts 48-51 may be fixed to the casing 46.

FIG. 9 illustrates another exemplary embodiment of the agitator 36. In this embodiment, the agitator 36 is configured as a single axis shaker; e.g., an x-axis shaker. The fixture 44 (see dashed outline), however, may be mounted to the agitator 36 in a manner that allows the fixture 44 and, thus, the object to be rotated about one or more other axes; e.g., y- and z-axes. The agitator 36, for example, may include a base 54 and a mount 56. The mount 56 may be connected to the base 54 by a first axle 58 (e.g., a y-axis axle) or other rotatable joint. The fixture 44 may be connected to the mount by a second axle 60 (e.g., a z-axis axle) or other rotatable joint. In this manner, the fixture 44 may be moved to change the direction the abrasive material is agitated within the aperture 22 (see FIGS. 4 and 5). The conditioning system 30 of FIG. 3, of course, is not limited to the exemplary agitator configurations described above and illustrated in FIGS. 6 and 9.

Referring to FIG. 3, the controller 38 may be implemented with a combination of hardware and software. The hardware may include memory and at least one processing device, which may include one or more single-core and/or multi-core processors. The hardware may also or alternatively include analog and/or digital circuitry other than that described above.

The memory is configured to store software (e.g., program instructions) for execution by the processing device, which software execution may control and/or facilitate performance of one or more operations such as those described in the processes below. The memory may be a non-transitory computer readable medium. For example, the memory may be configured as or include a volatile memory and/or a nonvolatile memory. Examples of a volatile memory may include a random access memory (RAM) such as a dynamic random access memory (DRAM), a static random access memory (SRAM), a synchronous dynamic random access memory (SDRAM), a video random access memory (VRAM), etc. Examples of a nonvolatile memory may include a read only memory (ROM), an electrically erasable programmable read-only memory (EEPROM), a computer hard drive, etc.

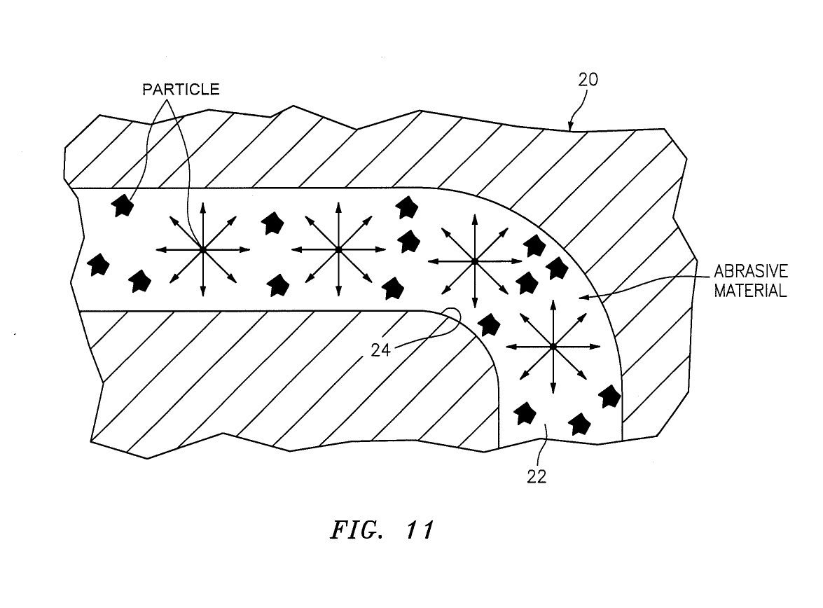

FIG. 10 is a flow diagram of a process involving a conditioning system such as the system 30 of FIG. 3. For ease of description, this process will be described with reference to the object 20 of FIGS. 1 and 2. However, the process of FIG. 10 is not limited to any particular object configurations.

In step 1000, the object 20 is disposed with the agitator 36. For example, referring to FIGS. 7 and 8, the object 20 may be packed in the casing 46 and nested between the inserts 48-51. The material displacement device 34 may also be fluidly coupled to the object 20 via the fluid conduits 40 and 42. The fixture 44 and, more particularly, the casing 46 may subsequently be mounted to the agitator 36 as illustrated in FIGS. 6 and 9.

In step 1002, a quantity of abrasive material is disposed within the aperture 22. For example, referring to FIGS. 3-5, the controller 38 may signal the material displacement device 34 to direct abrasive material from the material source 32 into the aperture 22 through the first fluid conduit 40; e.g., a source conduit.

The abrasive material may be or include substantially dry powder media. The term “powder” may describe a quantity (e.g., an agglomeration) of discrete particles with substantially uniform or varying sizes; e.g., average diameters. The particle size of one or more of the particles may be between about 001 inches (˜24.5 μm) and about 0.110 inches (˜2800 μm); e.g., between about 0.004 inches (˜106 μm) and about 0.55 inches (˜1400 μm). The process of FIG. 10, however, is not limited to any particular abrasive material particle sizes.

The powder media may be formed from metal and/or non-metal. Examples of suitable metal include, but are not limited to, tungsten carbide, steel grit, iron grit and/or super alloy nickel powder. Examples of suitable non-metal include, but are not limited to, silicon carbide, aluminum oxide, garnet and/or glass bead. The process of FIG. 10, however, is not limited to any particular abrasive material materials or forms thereof. For example, in some embodiments, the abrasive material may be configured as a slurry of the powder media mixed within a liquid. Such a slurry may be used where, for example, the abrasive material is to polish the surface 24 opposed to quickly reduce (e.g., cut) relatively high surface roughness.

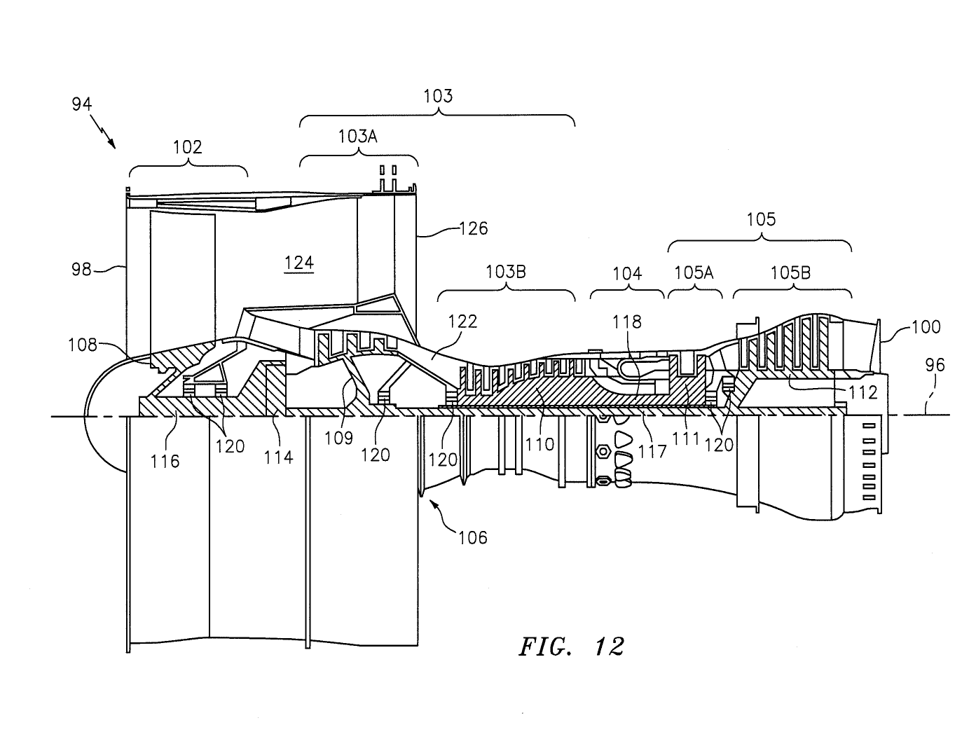

In step 1004, the abrasive material within the aperture 22 is agitated. The controller 38, for example, may signal the agitator 36 to move (e.g., shake and/or vibrate) the object 20 relative to one or more axes. The agitator 36, for example, may shake the object 20 back and forth along one or more axes; e.g., x-axis, y-axis and/or z-axis. The agitator 36 may also or alternatively rotate the object 20 back and forth about one or more axes; e.g., x-axis, y-axis and/or z-axis. Such movement, referring to FIG. 11, may cause the abrasive material particles to move in various directions within the aperture 22 and rub and/or impinge against the surface 24. This rubbing and/or impingement may cause the abrasive material particles to cut into the object's material and thereby reduce surface roughness of and/or polish the surface 24.

It is worth noting, the controller 38 may select (i) how the object 20 is moved relative to an axis and/or (ii) which axis or axes the object 20 is moved relative to based upon the specific configuration of the aperture 22. For example, the controller 38 may signal the agitator 36 to move the object 20 relative to each axis in order to condition each portion (e.g., inner, outer and side portions) of the surface at the bend illustrated in FIG. 11. In another example, where the aperture 22 extends straight through the object 20 along the x-axis (not shown), the controller 38 may signal the agitator 36 to move back and forth along the y-axis and/or the z-axis. The controller 38 may also signal the agitator 36 to rotate back and forth about the x-axis. In this manner, the object 20 movement will cause the abrasive material particles to impinge against the surface 24 without causing the particles to move out of the aperture 22. A similar technique may also be used to target specific portions of the surface 24; e.g., portions defining a curve or twist in the aperture 22.

The movement along and/or about the different axes may be performed sequentially. For example, the object 20 may be moved back and forth about the x-axis before the y-axis. Alternatively, the movement along and/or about the different axes may be performed substantially contemporaneously or overlap. For example, the object 20 may be moved back and forth along all three axes at the same time.

In step 1006, at least some of the abrasive material is removed (e.g., purged) from the aperture 22. The controller 38, for example, may signal the material displacement device 34 to direct a pulse or stream of purge fluid (e.g., compressed gas or liquid) into the aperture 22 through the first fluid conduit 40. This purge fluid may push some or substantially all of the abrasive material out of the aperture 22 and into the second fluid conduit 42; e.g., a return conduit. Depending upon the state of the purged abrasive material, this material may subsequently be discarded or returned to the material source 32 for later use.

In step 1008, the steps 1002, 1004 and 1006 may be repeated with new abrasive material to further reduce the surface roughness of and/or polish the surface 24. The new abrasive material may be the same type of abrasive material as was disposed in the step 1002. Alternatively, the new abrasive material may be different than the abrasive material of the step 1002. For example, the new abrasive material may be composed from different material and/or have different particle sizes. The new material may also or alternatively be provided in a different form. The abrasive material provided in the step 1002, for example, may be dry powder media selected to quickly reduce surface roughness. The new abrasive material, on the other hand, may be a slurry of powder media in a liquid tailored for (e.g., fine) polishing of the surface 24. In still another example, the liquid content in the abrasive material may be changed between repetitions of the step 1002.

It is worth noting, the step 1008 may be repeated as may times as necessary in order to condition the surface 24. The step 1008 may also be omitted when the surface 24 is conditioned to specification during the step 1004.

In some embodiments, the process of FIG. 10 may include a step of forming the object 20. The object 20 may be formed using one or more manufacturing processes which include, but are not limited to, additive manufacturing, casting, milling, forging and machining. The term “additive manufacturing” may describe a process where an additive manufacturing system builds up a part or parts in a layer-by-layer fashion. For example, for each layer, the additive manufacturing system may spread and compact a layer of additive manufacturing material (e.g., metal powder and/or non-metal powder) and solidify one or more portions of this material layer with an energy beam; e.g., a laser beam or an electron beam. Examples of an additive manufacturing system include, but are not limited to, a laser sintering system, an electron beam system, a laser powder deposition system and an EB wire deposition system. Examples of metal(s) from which the object 20 may be formed include, but are not limited to, nickel (Ni), titanium (Ti), steel, stainless steel, cobalt (Co), chromium (Cr), tungsten (W), molybdenum (Mo) and/or alloys including one or more of the foregoing metals such as Waspaloy, Stellite, Aluminum, etc. The object 20, however, is not limited to being formed from the foregoing materials.

In some embodiments, the process of FIG. 10 may include a step of displacing the abrasive material within the aperture 22. The controller 38, for example, may signal the material displacement device 34 to slightly displace (e.g., push and/or pull) the abrasive material along a centerline of the aperture 22. The abrasive material may be displaced, for example, by pulsing fluid (e.g., compressed gas or liquid) into the aperture 22 through the first fluid conduit 40. This displacement may be repeated for one or more iterations, thereby causing the abrasive material to rub against and cut into the surface 24. This rubbing may further aid in reducing the surface roughness of and/or polishing the surface 24.

The abrasive material may be displaced one or more times while the object 20 is being moved by the agitator 36. The abrasive material may also or alternatively be displaced one or more times before, after and/or during pauses between movements of the object 20 with the agitator 36.

In some embodiments, where the object 20 includes a plurality of apertures 22, the material displacement device 34 may be fluidly coupled to a select one or few of these apertures 22. In this manner, the surfaces 24 defining those respective apertures 22 are at least partially conditioned. Alternatively, the material displacement device 34 may be fluidly coupled to each of the apertures 22, sequentially or contemporaneously, to condition at least a portion of each surface 24.

In some embodiments, the fixture 44 may be configured to receive and house a plurality of objects 20. In this manner, the conditioning system 30 may collectively condition surfaces of the objects 20, which may reduce manufacturing time and/or costs.

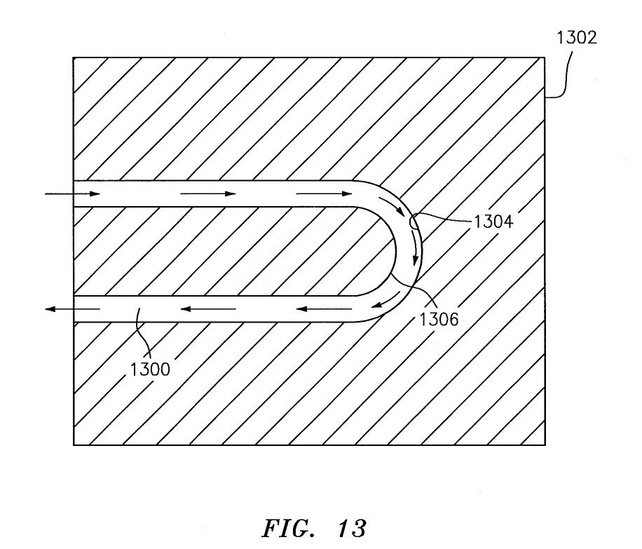

The object(s) 20 conditioned by the conditioning system 30 may have various configurations and may be included in various types of apparatuses and systems. The object 20, for example, may be configured as a bearing race or a rotor blade of a turbine engine. FIG. 12 illustrates an exemplary embodiment of such a turbine engine 94; e.g., a geared turbofan engine.

The turbine engine 94 of FIG. 12 extends along an axial centerline 96 between an upstream airflow inlet 98 and a downstream airflow exhaust 100. The turbine engine 94 includes a fan section 102, a compressor section 103, a combustor section 104 and a turbine section 105. The compressor section 103 includes a low pressure compressor (LPC) section 103A and a high pressure compressor (HPC) section 103B. The turbine section 105 includes a high pressure turbine (HPT) section 105A and a low pressure turbine (LPT) section 105B. The engine sections 102-105 are arranged sequentially along the centerline 96 within a housing 106.

Each of the engine sections 102-103B, 105A and 105B includes a respective rotor 108-112. Each of these rotors 108-112 includes a plurality of rotor blades arranged circumferentially around and connected to one or more respective rotor disks. The rotor blades, for example, may be formed integral with or mechanically fastened, welded, brazed, adhered and/or otherwise attached to the respective rotor disk(s).

The fan rotor 108 is connected to a gear train 114, for example, through a fan shaft 116. The gear train 114 and the LPC rotor 109 are connected to and driven by the LPT rotor 112 through a low speed shaft 117. The HPC rotor 110 is connected to and driven by the HPT rotor 111 through a high speed shaft 118. The shafts 116-118 are rotatably supported by a plurality of bearings 120; e.g., rolling element and/or thrust bearings. Each of these bearings 120 is connected to the engine housing 106 by at least one stationary structure such as, for example, an annular support strut.

During operation, air enters the turbine engine 94 through the airflow inlet 98, and is directed through the fan section 102 and into a core gas path 122 and a bypass gas path 124. The air within the core gas path 122 may be referred to as “core air”. The air within the bypass gas path 124 may be referred to as “bypass air”. The core air is directed through the engine sections 103-105 and exits the turbine engine 94 through the airflow exhaust 100 to provide forward engine thrust. Within the combustor section 104, fuel is injected into a combustion chamber and mixed with the core air. This fuel-core air mixture is ignited to power the turbine engine 94. The bypass air is directed through the bypass gas path 124 and out of the turbine engine 94 through a bypass nozzle 126 to provide additional forward engine thrust. Alternatively, at least some of the bypass air may be directed out of the turbine engine 94 through a thrust reverser to provide reverse engine thrust.

The object 20 may be included in various turbine engines other than the one described above. The object 20, for example, may be included in a geared turbine engine where a gear train connects one or more shafts to one or more rotors in a fan section, a compressor section and/or any other engine section. Alternatively, the object 20 may be included in a turbine engine configured without a gear train. The object 20 may be included in a geared or non-geared turbine engine configured with a single spool, with two spools (e.g., see FIG. 12), or with more than two spools. The turbine engine may be configured as a turbofan engine, a turbojet engine, a propfan engine, or any other type of turbine engine. The present invention therefore is not limited to any particular turbine engine types or configurations. Furthermore, while the object 20 is described above as being included in a turbine engine, the object 20 may also be configured with various non-turbine engine systems; e.g., HVAC systems, automobile systems, etc.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. A process involving an agitator, the process comprising:
disposing an object with the agitator, the object including an aperture therein;
disposing abrasive material within the aperture; and
agitating the abrasive material by moving the object using the agitator.

2. The process of claim 1, wherein the moving comprises shaking the object using the agitator.

3. The process of claim 1, wherein the moving comprises moving the object relative to a first axis using the agitator.

4. The process of claim 3, wherein the moving further comprises moving the object relative to a second axis using the agitator.

5. The process of claim 4, wherein the moving further comprises moving the object relative to a third axis using the agitator.

6. The process of claim 3, wherein the moving of the object relative to the first axis comprises moving the object back and forth along the first axis.

7. The process of claim 3, wherein the moving of the object relative to the first axis comprises moving the object back and forth about the first axis.

8. The process of claim 1, further comprising displacing the abrasive material using a material displacement device.

9. The process of claim 8, wherein the abrasive material is displaced by a pulse of fluid directed from the material displacement device.

10. The process of claim 8, wherein the displacing is performed during the moving of the object.

11. The process of claim 1, further comprising:
removing at least some of the abrasive material from the aperture;
disposing second abrasive material into the aperture; and
agitating the second abrasive material by moving the object using the agitator.

12. The process of claim 1, further comprising additive manufacturing at least a portion of the object that includes the aperture.

13. The process of claim 1, further comprising casting at least a portion of the object that includes the aperture.

14. The process of claim 1, wherein the aperture is one of a plurality of apertures in the object, and the abrasive material is disposed in at least one of the apertures.

15. The process of claim 1, wherein the abrasive material comprises dry powder media.

16. The process of claim 1, wherein the abrasive material comprises a slurry of powder media in a liquid.

17. The process of claim 1, wherein the agitating of the abrasive material reduces surface roughness of an internal surface of the object, which internal surface defines at least a portion of the aperture.

18. A system for conditioning an internal surface of an object, the internal surface defining at least a portion of an aperture in the object, the system comprising:
a material displacement device adapted to dispose abrasive material into the aperture; and
an agitator adapted to agitate the abrasive material by moving the object, wherein the agitation of the abrasive material reduces surface roughness of the internal surface.

19. The system of claim 18, wherein the agitator is adapted to move the object along at least one axis.

20. The system of claim 18, wherein the agitator is adapted to move the object about at least one axis.
